(19) United States
(12) Patent Application Publication
(10) Pub. No.: US 2016/0298858 A1
(43) Pub. Date: Oct. 13, 2016

(54) BASE FOR A FREELY INSTALLABLE COOKER

(71) Applicant: INDESIT COMPANY S.P.A., Fabriano (IT)

(72) Inventors: SANDRO CICCACCI, Sassoferrato (IT); EGLE ARMONAVICIUTE, Cagli (IT); MAURIZIO TURSINI, Fabriano (IT); MICRO PALPACELLI, Jesi (IT)

(73) Assignee: INDESIT COMPANY S.P.A., FABRIANO (IT)

(21) Appl. No.: 15/037,737

(22) PCT Filed: Oct. 30, 2014
(86) PCT No.: PCT/IB2014/065719

§ 371 Date: May 19, 2016

(30) Foreign Application Priority Data
Nov. 21, 2013 (IT) PR2013A000095

(51) Int. Cl. F24C 15/30; F24C 15/08; A47J 37/06

(52) U.S. Cl. CPC F24C 15/30; A47J 37/06; F24C 15/08

(57) ABSTRACT

Freely installable cooker comprising a support structure in turn comprising a support base said base being an assembly of several panels and having a modular structure so as to reach the desired dimensions. The modular structure of the base comprises a plurality of panels in turn comprising:
a first panel;
a second panel.

The first and second panels contribute to defining a shared bottom surface. Said plurality of panels are coplanar.

### TECHNICAL FIELD

The present invention relates to a freely installable cooker and a method for its realization.

### STATE OF THE ART

Freely installable cookers are known wherein various household electrical appliances are assembled in a support structure, each in a specific housing afforded inside said structure. For example, for realization of a predetermined freely installable cooker, a predetermined cooker hob and a predetermined oven are added to a given structure.

Use of a different support structure is provided each time to create cookers having different plan dimensions.

A drawback of said construction solution is linked to the limited possibility of customising a specific product. This leads to considerable costs, since numerous assembly lines must be developed to diversify production in order to satisfy the product differences demanded by the market.

### AIM OF THE INVENTION

In this context, the technical task underpinning the present invention is to provide a freely installable cooker which allows a high level of customization to be obtained while reducing production costs to a minimum. A further object of the present invention is allowing a user to intervene on a cooker already purchased in order to adapt it to changed needs.

### BRIEF DESCRIPTION OF THE DRAWINGS

The technical task set and the objects specified are substantially attained by a freely installable cooker comprising the technical characteristics as set out in one or more of the accompanying claims.

Further characteristics and advantages of the present invention will become more apparent from the following indicative, and hence non-limiting, description of a preferred, but not exclusive, embodiment of a freely installable cooker as illustrated in the appended drawings, in which:

FIGS. 1 and 4 show a portion of the cooker according to the present invention;

FIGS. 2 and 3 show components to be used on the cooker according to the present invention;

FIG. 5 is an exploded view of FIG. 4;

FIGS. 6, 7, 8 show a cooker according to the present invention partially assembled and in different configurations;

FIGS. 9, 10, 11 show a side view of FIGS. 6, 7, 8;

FIGS. 12, 13 show a cooker according to the present invention partially assembled and in different configurations;

FIG. 14 shows a different viewpoint to the one shown in FIG. 13;

FIG. 15 shows a view from above of FIG. 12;

FIG. 16 shows a base (in an assembled configuration and in a partially larger-scale view) of the cooker according to the present invention;

FIG. 17 shows a base (in an assembled configuration and in a partially larger-scale view) of the cooker according to the present invention;

FIGS. 18 and 19 show a plan view and a perspective view of a cooker according to the present invention, partially assembled;

FIG. 20 shows different cookers according to the present invention;

FIG. 21 shows a larger-scale view of the cooker according to the present invention;

FIG. 22 shows a detail of FIG. 21;

FIGS. 23 and 24 show a component of FIG. 21 in two different positions; said figures being shown considering an opposite viewpoint with respect to the one of FIG. 22;

FIG. 25 shows a detail of FIG. 21 in an assembled configuration.

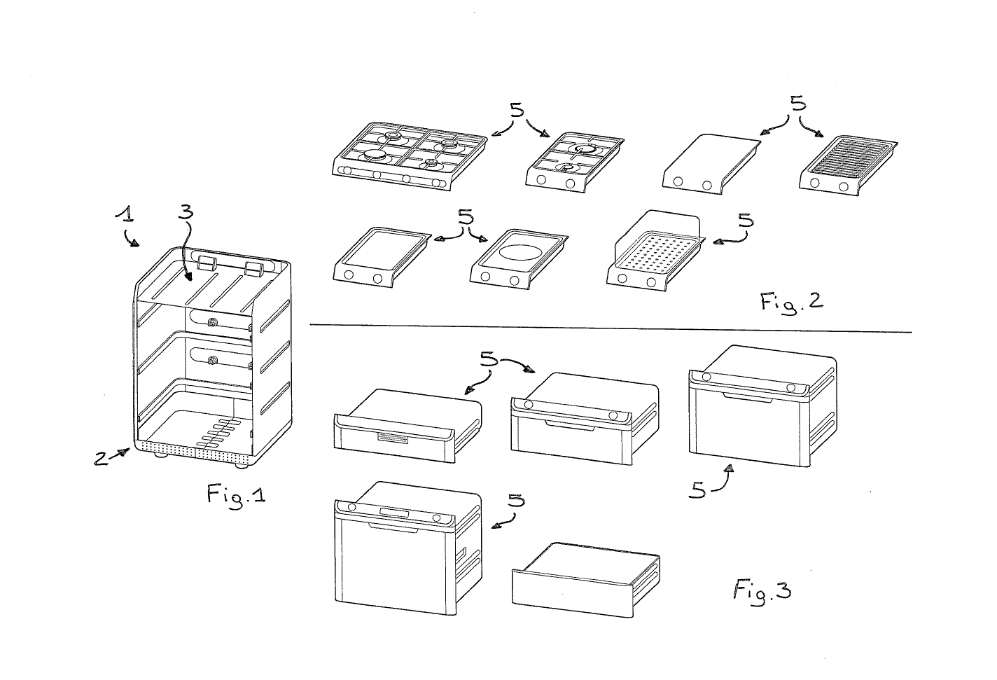

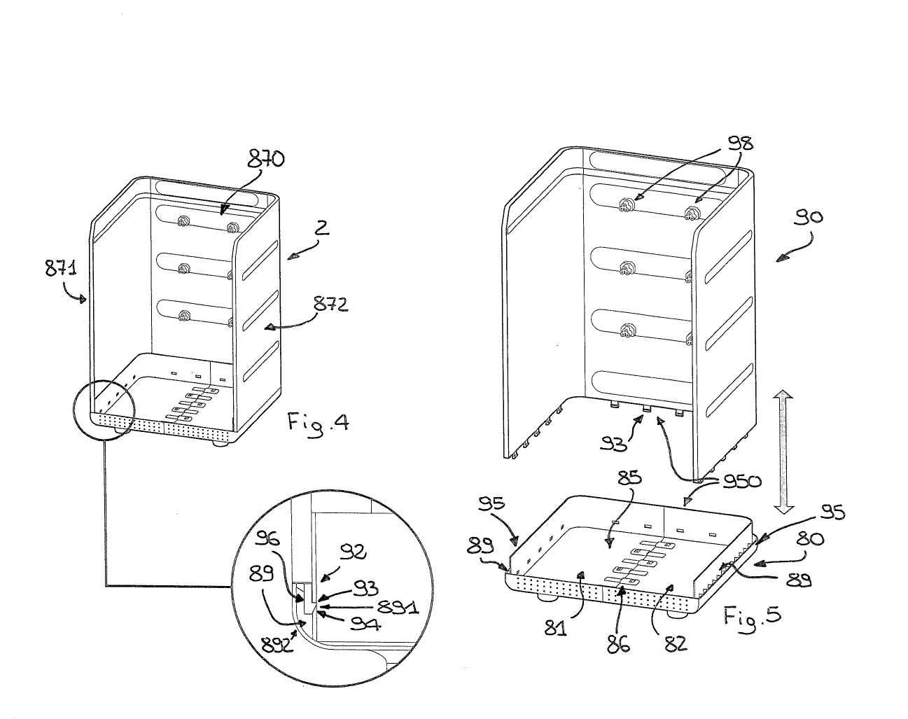

### DETAILED DESCRIPTION OF PREFERRED EMBODIMENTS OF THE INVENTION

In the accompanying drawings, reference number 1 indicates a freely installable cooker. “Freely installable cooker” means an independent structure which allows cooking of food products. It is to be considered an alternative to integrated recessed cookers developing continuously on equipped walls. Said freely installable cooker 1 comprises a support structure 2 in turn comprising a base 80. Preferably, the base 80 is an assembly of several panels. It has a modular structure in order to reach the desired dimensions.

The modular structure of the base 80 comprises a plurality of panels in turn comprising:
a first panel 81;
a second panel 82.

The first and second panels 81, 82 contribute to defining a shared bottom surface 85. Said plurality of panels are coplanar.

Opportunely, said plurality of panels may comprise a third panel 83 interposed between the first and second panels 81, 82. The third panel 83 contributes to defining said shared bottom surface 85. In this way, the third panel 83 allows the base 80 to be elongated with respect to a situation in which only the first and the second panels 81, 82 are present.

For similar considerations, said plurality of panels may comprise a fourth panel adjacent to the third panel 83 and interposed between the first and the second panels 81, 82. The fourth panel contributes to defining the shared bottom surface 85.

The freely installable cooker 1 further comprises connection means 86 of two adjacent panels of the modular structure. The two adjacent panels may be chosen from said plurality of panels. The connection means 86 are afforded in a single piece with said two panels.

The connection means 86 of the two adjacent panels have a male-female type connection. Opportunely, the connection means 86 of the two adjacent modules comprise a plurality of inserts 861 which engage in corresponding housings 862. Opportunely, the inserts 861 engage in the housings 862 by means of elastic deformation. Advantageously, both the two adjacent modules alternate an insert and a housing forming part respectively of said plurality of inserts and said plurality of housings.

The freely installable cooker 1 comprises one or more functional modules 5 (typically cooking modules).

The support structure 2 comprises three side walls 870, 871, 872 in at least two of which are afforded guide and support means 91 of at least one of said functional modules 5. The base 80 is quadrilateral. The base 80 comprises a groove 89 which surrounds the base 80 on three sides and in which the three side walls 870, 871,872 are engaged.

Opportunely, the three side walls 870, 871, 872 described above comprise a first and a second wall 871, 872 and a bottom wall 870 which connects them. The first and second wall 871, 872 are vertical. On the first and second wall 871, 872, there are respectively afforded at least a first and a second insertion and extraction guide 210, 220 of said first functional module 5. The first and the second insertion and extraction guide 210, 220 allow removable connection of the first functional module 5 with respect to the support structure 2. Opportunely, the first and second insertion and extraction guides 210, 220 extend horizontally. The first and the second insertion and extraction guides 210, 220 form part of the guide and support means 91 indicated above.

The first insertion and extraction guide 210 comprises an inner channel 211 open at one end. The first functional module 5 comprises a protrusion 50 which, in a configuration of connection to the support structure 2, is inserted in said inner channel 211.

The guide and support means 91 could be additional elements applied with attachment means to the remaining parts of the first and second wall 871, 872. In an alternative embodiment, the guide and support means 91 could be integrated into the first and into the second wall 871, 872 (and not separable from said walls). The first and the second wall 871, 872 could comprise a sandwich structure. In this case, the first and the second wall 871, 872 could comprise an outer covering 912, an inner covering 911 and interposed thermal insulation. In this case, the inner covering 911 defines the guide and support means 91. Typically, the inner and outer covering 911, 912 are a metal material.

The third panel 83 of the support structure 2 comprises a first side 831 adjacent to a first edge 811 of the first panel 81; the connection means 86 are afforded at least along the first edge 811 and the first side 831.

In the preferred embodiment, the first and/or the second and/or the third and/or the fourth panel are a plastic material. The freely installable cooker 1 could also comprise further panels. Preferably, all the panels of the base 80 extend in a row one with the other along a straight line. Opportunely, the first panel 81 extends in a single piece; this could be repeated for the second panel 82 and/or the third panel 83 and/or the fourth panel.

Opportunely, the present invention further comprises a method of realisation of a base 80 of a freely installable cooker 1. Opportunely, said freely installable cooker 1 has one or more of the characteristics described above. The method further comprises the step of connecting a plurality of panels (possibly also with different shapes and dimensions) in order to obtain a base 80 having pre-established dimensions.

Said first functional module 5 described above is advantageously removable with respect to the support structure 2. Opportunely, the first cooking module 5 is interchangeable (and replaceable with other functional modules). It is positionable in a first housing 20 of the support structure.

Opportunely, the freely installable cooker 1 comprises a resting surface 3 accessible from above.

The freely installable cooker 1 further comprises a front wall 31 which extends between the top and the bottom of the freely installable cooker 1. Typically, the front wall 31 is an opposite wall to a rear wall which is destined to face a wall of the compartment in which the freely installable cooker 1 is positioned.

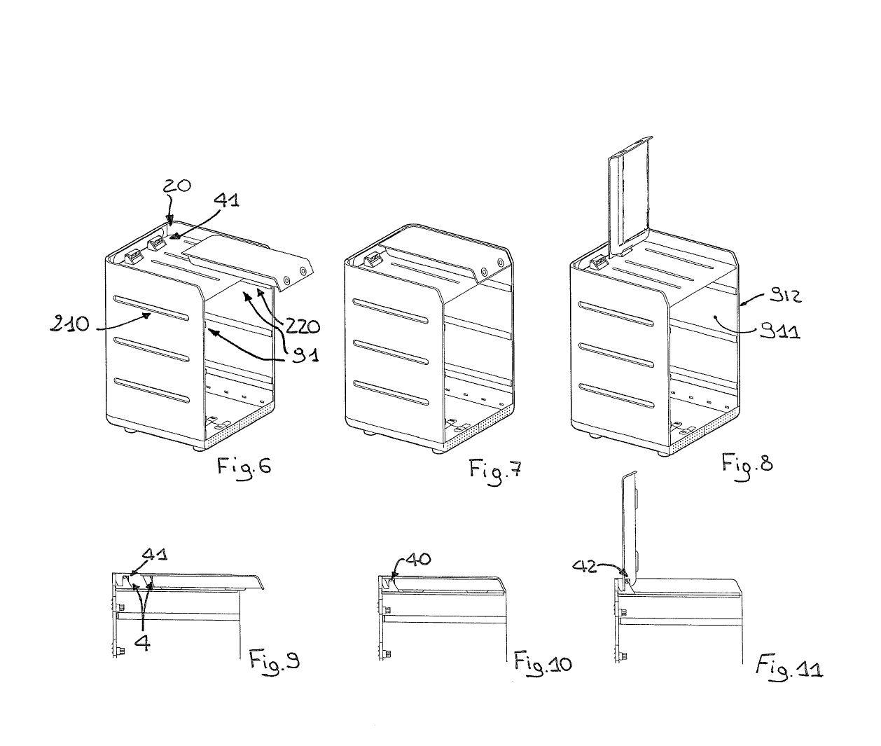

The first housing 20 may be afforded on said resting surface 3 (see FIGS. 6, 7, 8). This case occurs especially when the first cooking module 5 is a cooker hob (see for example FIG. 2 or 3). Opportunely, the first cooking module 5 could be an induction, grill, steam cooker hob, Tappan Yaki, or Wok (see FIG. 2).

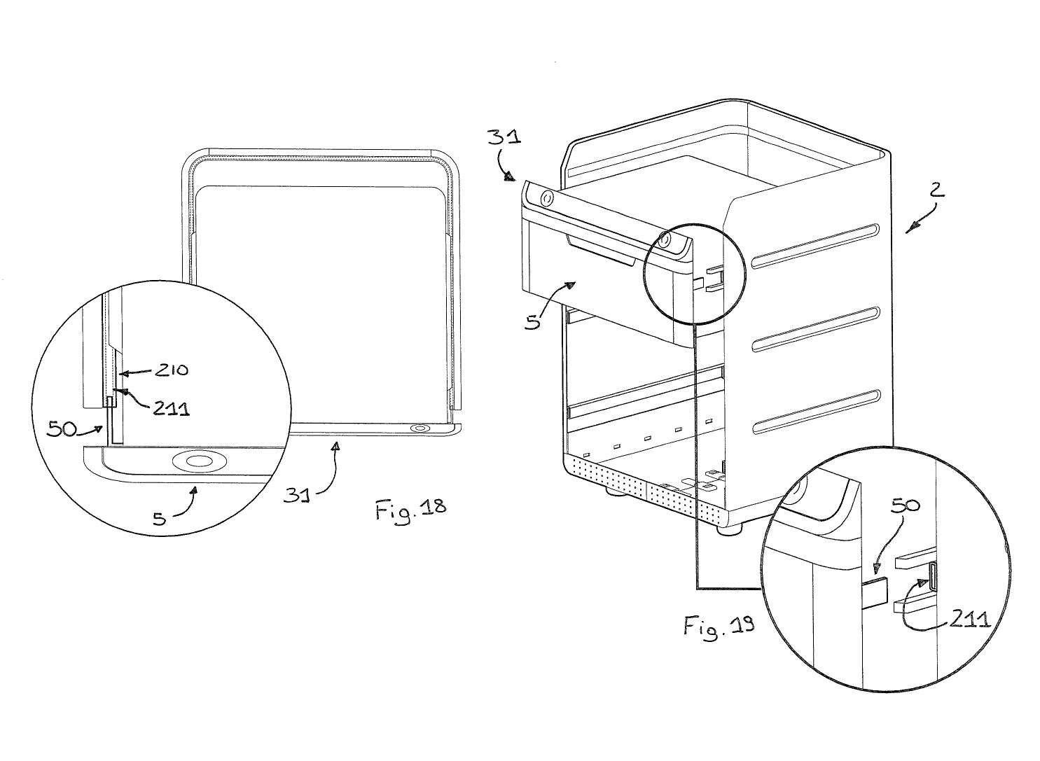

In an alternative solution, the first housing 20 could, however, be positioned beneath the resting surface 3 (see FIG. 12 or 13 or 14 in which the resting surface 3 is omitted). In this case, the front wall 31 may be defined at least partly by a door of said first functional module 5. Also in this case, the first functional module 5 is a cooking module and, in particular, an oven.

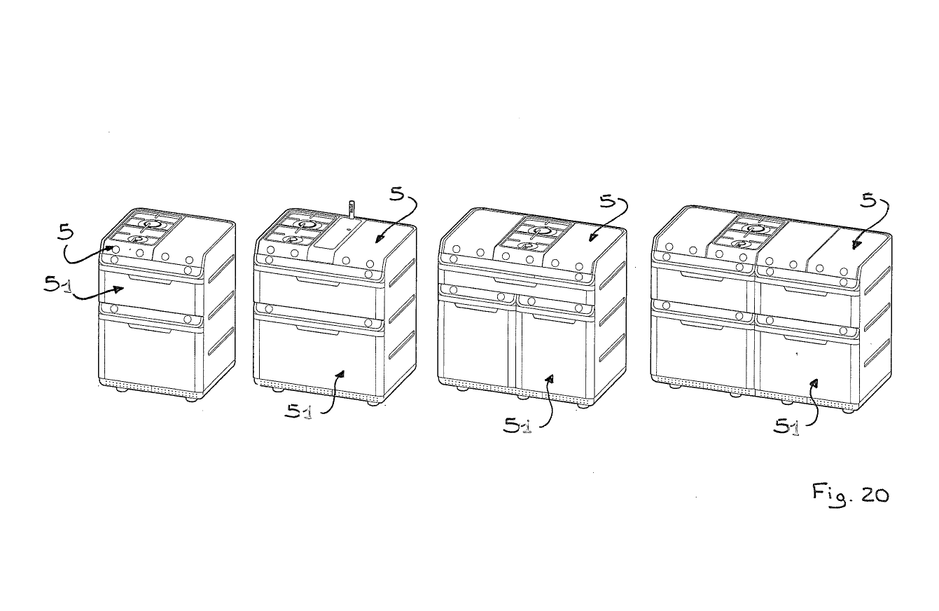

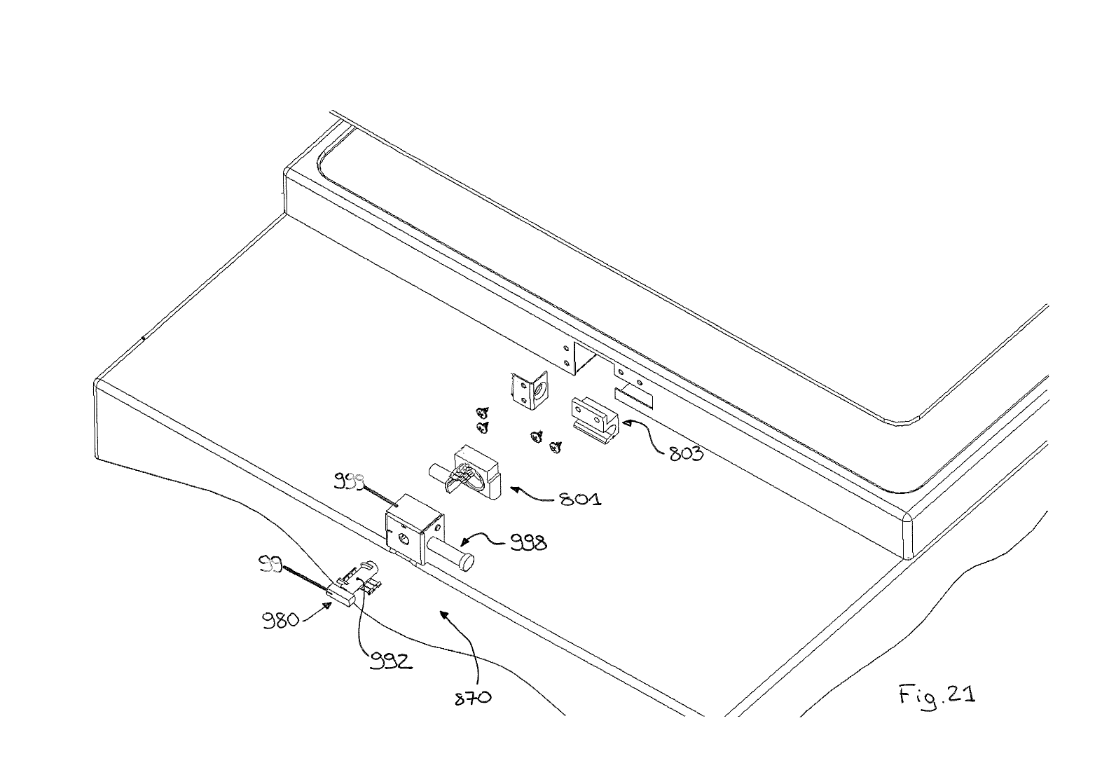

The freely installable cooker 1 could also comprise both the first cooking module 5 and a functional additional module 51 positioned beneath the resting surface 3. The functional additional module 51 is removable, interchangeable and housed in the support structure 2 (see, for example, FIG. 20). Said functional additional module 51 could be an oven or another household electrical appliance (for example, a dishwasher or a device for refrigerating food products). Opportunely, beneath the resting surface 3 a plurality of functional additional modules 51 could be present. Preferably, the functional additional modules 51 are different household electrical appliances. They could be alongside each other horizontally or stacked. For each functional additional module 51, what is described here could be repeated with reference to the first cooking module 5.

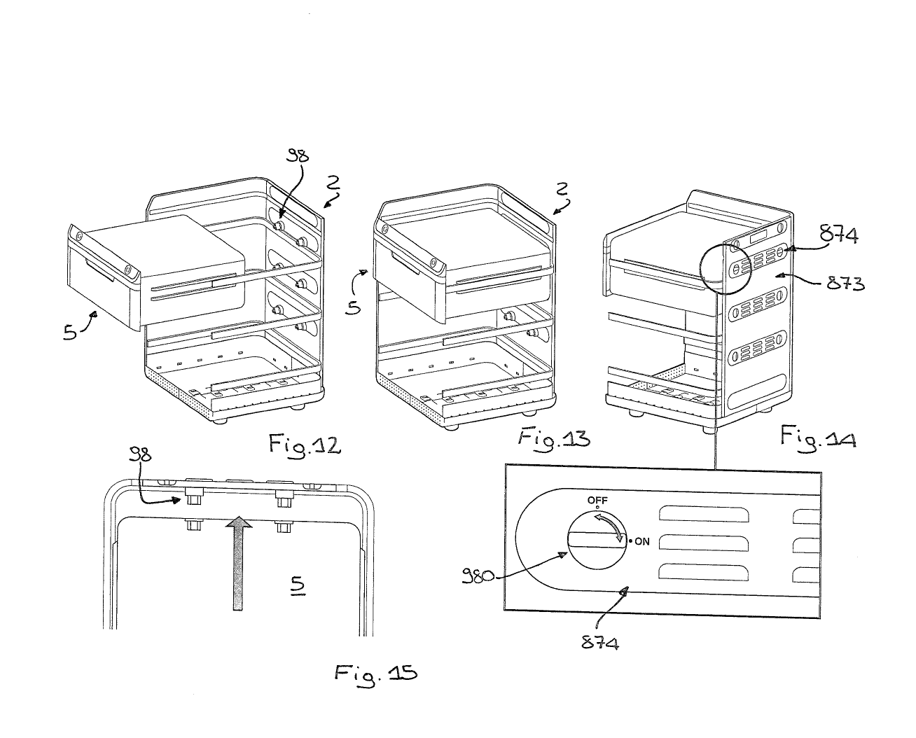

Reference is now made to a possible embodiment wherein the first cooking module 5 is:
positionable on the resting surface 3;
mobile between a first and a second position. In the first position (see FIG. 7), the first cooking module 5 is substantially horizontal. In the second position (see FIG. 8), the first cooking module 5 is tilted upwards with respect to the first position. Opportunely, said tilting is by means of a first hinge 40. This assists cleaning of the resting surface 3.

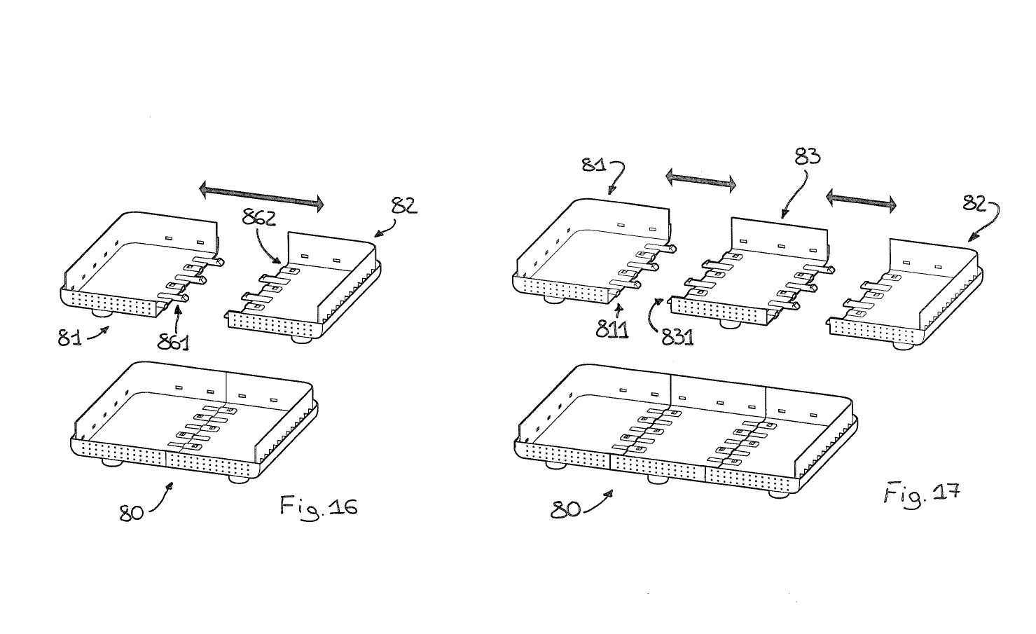

The freely installable cooker 1 comprises electrical supply means 4 of the first cooking module 5. In the exemplary embodiment shown in FIGS. 6-11, the electrical supply means 4 comprise a first connector 41 rotatable solidly joined to said first hinge 40. Opportunely, the electrical supply means 4 comprise a second connector 42 solidly joined to the first cooking module 5. The first and second connectors 41, 42 may remain connected both in the first and in the second position. Advantageously, the freely installable cooker 1 comprises a switch of the electrical supply means 4. Said switch acts to prevent functioning of said first cooking module 5 when it is in the second position. The switch may be mechanically activated, for example by a mechanical abutment with which the switch comes into contact during passage from the first to the second position. Alternatively, the switch could be controlled gyroscopically.

The object of the present invention is also a system comprising:
a freely installable cooker 1 having one or more of the characteristics described above;
a second cooking module, the first cooking module 5 being replaceable with the second module.

The first and second cooking modules could belong to a different type of cooking points (for example, one could be an induction cooker hob and the other a steam cooker hob).

It could also be that the second model is a washing module for articles. In this case, the first cooking module 5 (to be replaced) is opportunely, but not necessarily, an oven (and is positioned beneath the resting surface 3).

An object of the present invention is also a method of realising a freely installable cooker 1 comprising the steps of:
realising a support structure 2 forming part of the freely installable cooker 1 and comprising a first housing 20;
choosing a predetermined cooking module 5 from a group of separate, interchangeable cooking modules positionable in said first housing 20 and connectible to the support structure 2;
connecting said predetermined cooking module 5 to said support structure 2.

Opportunely, the step of choosing the predetermined cooking module 5 occurs during assembly. The method could, however, provide the step of the final user replacing said predetermined cooking module 5 with another cooking module or more generally with another functional module.

The support structure 2, in addition to the base 80, further comprises a containment structure 90 which extends between the top and the bottom (in particular vertically), distancing itself from the base 80. The three side walls 870, 871, 872 described above are integrated into said containment structure 90 (in particular they form said containment structure 90).

Advantageously, the support structure 2 comprises connection means 92 of said base 80 and said containment structure 90. The connection means 92 comprise engagement means 93 and housing means 94 of said engagement means 93. The engagement means 93 and said housing means 94 are afforded where one is in said base 80 and the other is in said containment structure 90. The connection between said engagement means 93 and said housing means 94 occurs at least at junction zones 95 of the two side walls 871, 872 with the base 80 and at the junction zone 950 of the bottom wall 870 and said base 80.

Advantageously, the connection means 92 comprise elastic deformation means 96 attachable in said housing means 94. Typically, said connection means 92 comprise deformable tabs.

The freely installable cooker 1 comprises activation means 98 of functioning of said first functional module 5. They are advantageously afforded at said bottom wall 870 (or in any case in a zone behind the freely installable cooker 1). The activation means 98 may be activated manually in a first configuration, in which there is a correct connection of said first module 5 and said containment structure 90 (or more generally of the support structure 2). In a particular embodiment, the activation means 98 may comprise a selector 980. Said selector 980 only in said first configuration (i.e. when there is a correct connection and positioning of the first module) allows the user to activate or deactivate the functioning of the first functional module 5. Alternatively (non-preferred embodiment), said selector 980 could be activated directly by the correct connection of said first cooking module 5 and said containment structure 90.

The activation means 98 assume a second configuration in which they prevent activation for functioning of the first functional module 5; opportunely, the passage from the second to the first configuration is determined by a mechanical thrusting action dictated by reaching of an end of stroke of the first functional module 5 (preferably along the guide and support means 91) and manual activation of said selector 980.

In said first configuration, the activation means 98 therefore come into contact with said first functional module 5. Opportunely, the first functional module 5 comprises an interface 801 destined to couple with said selector 980.

The activation means 98 therefore define a switch which, in the first configuration, is activated by the selector 980.

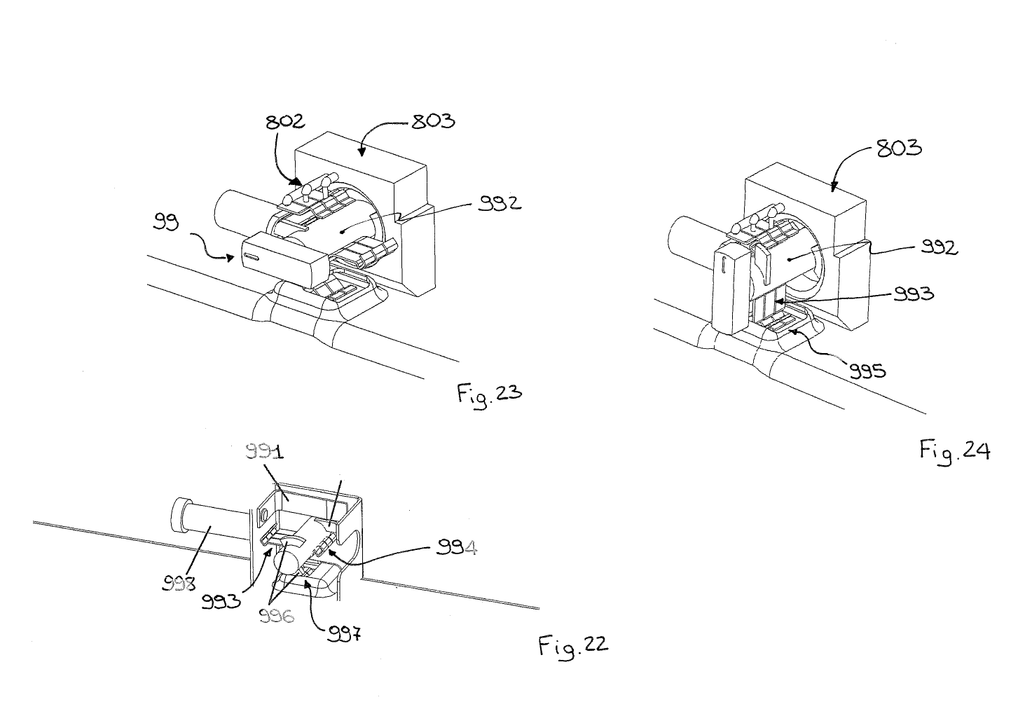

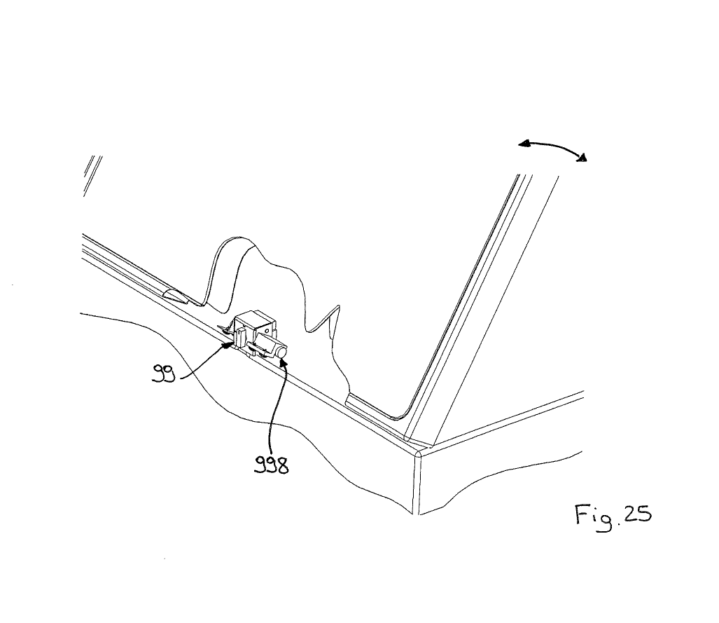

In the preferred embodiment shown in FIGS. 21-24, the activation means 98 (particularly the selector 980) comprise a knob 99. The selector 980 may assume a first position in which it prevents power supply of the first functional module 5. The selector 980 may assume a second position in which power supply of the first functional module 5 is permitted. The activation means 98 comprise a tab 991 which, in a blocking position, prevents rotation of the knob 99 from the first to the second position. The tab 991 may also assume an activation configuration in which it allows rotation of the selector 980 from the first to the second position. The second position of the selector 980 is assumed in said first configuration, i.e. when there is a correct connection and positioning of the first functional module 5. In fact, the first functional module 5 which has reached the end of stroke into said first configuration determines a movement of the tab 991 allowing rotation of the knob 99. The selector 980 comprises a stem 992 to which the knob 99 is solidly joined. The stem 992 in turn comprises at least a first and a second electrical contact 993, 994. Opportunely, the first and the second electrical contact 993, 994 are elastic. In the second position of the selector 980, the first electrical contact 993 places in electrical communication said stem 992 and a power source 995 afforded on the support structure 2. In the second position of the selector 980 the second electrical contact 994 places in electrical communication said stem 992 and said first functional module 5.

Opportunely, the interface 801 of the first functional module 5 which interacts with the selector 980 comprises electrical wires 802 powered by said second electrical contact 994 and which allow power supply of the first functional module 5.

In this way, in the second position of the selector 980, electrical power supply of the first functional module 5 is permitted through the stem 992.

Advantageously, the stem 992 comprises an element (for example a fin 996) which, in the second position of the selector 980, interacts with a corresponding component 997 (which defines a housing 803) afforded in said first functional module 5 to prevent extraction of the first functional module 5. Opportunely, the freely installable cooker 1 comprises a pin 998 which engages in a counter-shaped housing 803 afforded on the first functional module 5. Opportunely, the pin 998 is solidly joined to a housing 999 of the selector 980. In said housing 999, said tab 991 is also advantageously housed. In this way, the first functional module 5 may rotate with respect to the support structure 2, which is solidly joined to the housing of the tab 991.

The bottom wall 870 comprises:
a frame 873 which delimits an opening;
infill material 874 which closes the opening, said activation means 98 being applied to said infill material 874.

The freely installable cooker 1 comprises a groove 89 which extends at the junction zones 95 of the two side walls 871, 872 with the base 80 and at the junction zone 950 of the bottom wall 870 and said base 80. The groove 89 is defined at least by:
a first side 891 in which said housing means 94 are advantageously afforded;
a second side 892, the engagement means 93 being insertable between the first and the second side 891, 892 (and coming into contact with the first and the second wall 871, 872).

The present invention has numerous advantages. In particular, it allows realization of a plurality of basic components which may then be assembled in various ways to allow the desired customisation of the freely installable cooker 1. In particular, the various components of the base 80 may be assembled to obtain the desired dimensions. Furthermore, assembly of the various components of the base 80 is extremely rapid and does not require the use of particular tools. The invention as conceived is susceptible to numerous modifications and variants, all falling within the scope of the inventive concept characterized thereby. Furthermore all the details can be replaced by other technically equivalent elements. In practice, all the materials used, as well as the dimensions, can be any according to requirements.

1. Freely installable cooker comprising a support structure including a base, characterized in that said base is an assembly of several panels and has a modular structure that defines a desired set of dimensions.

2. The freely installable cooker of claim 1, characterized in that the modular structure of the base includes a plurality of panels including:
a first panel; and
a second panel, wherein
the first and second panel at least partially define a common bottom surface.

3. The freely installable cooker of claim 2, characterized in that said plurality of panels includes a third panel interposed between the first and second panels, said third panel further defining the common bottom surface.

4. The freely installable cooker of claim 2, characterized in that said plurality of panels includes a fourth panel adjacent to the third panel and interposed between the first and second panels said fourth panel further defining the common bottom surface.

5. The freely installable cooker of claim 4, further comprising:
connection means of two adjacent panels of the modular structure, said two panels forming part of said plurality of panels.

6. The freely installable cooker of claim 5, characterized in that the connection means of two adjacent modules defines a male-female type connection.

7. The freely installable cooker of claim 5, characterized in that the third panel of the support structure comprises a first side adjacent to a first edge of the first panel; the connection means being disposed at least along the first edge and the first side.

8. The freely installable cooker of claim 2, characterized in that said plurality of panels are coplanar.

9. The freely installable cooker of claim 1, characterized in that the support structure includes three side walls, wherein at least two of the three side wails include guide and support means of at least one cooking module; the base being quadrilateral and comprising a groove which surrounds the base on three sides and into which said three side walls are engaged.

10. A method for forming a lower base of a freely installable cooker, characterized in that the freely installable cooker connects a plurality of modular elements of different shapes and dimensions, so as to obtain a base having predetermined dimensions.
